(19) United States
(12) Patent Application Publication
(10) Pub. No.: US 2012/0152709 A1
(43) Pub. Date: Jun. 21, 2012

(54) KEY DEVICE FOR ELECTRONIC APPARATUS

(75) Inventors: TING-TING ZHAO, Shenzhen City (CN); XIAO-HUI ZHOU, Shenzhen City (CN); MIN-LI LI, Shenzhen City (CN); HONG LI, Shenzhen City (CN)

(73) Assignees: HON HAI PRECISION INDUSTRY CO. LTD., Tu-Cheng (TW); HONG FU JIN PRECISION INDUSTRY (ShenZhen) CO., LTD., Shenzhen City (CN)

(21) Appl. No.: 13/070,531

(22) Filed: Mar. 24, 2011

(30) Foreign Application Priority Data
Dec. 20, 2010 (CN) 201010596692.2

(51) Int. Cl. H01H 13/14

(52) U.S. Cl. 200/341

(57) ABSTRACT

An exemplary key device includes a circuit board, a frame, a cap, a partition board and two protrusions. The circuit board has two contacts thereon. The cap is configured on the frame and includes a bottom surface facing the circuit board. The partition board extends down from the bottom surface and abutting against the circuit board. The two protrusions are at two opposite sides of the partition board. The two protrusions extend down from the bottom surface, and each includes a distal end adjacent and above a respective one of the contacts of the circuit board.

### BACKGROUND

1. Technical Field

The present disclosure generally relates to key devices, and particularly to a key device capable of being applied to electronic apparatuses.

2. Description of Related Art

Nowadays, key devices are extensively used in various electronic apparatuses for users to input operational instructions. A general key device usually includes a circuit board and a cap. The circuit board includes contacts configured thereon. The cap usually includes two or more protrusions extending from a bottom thereof. Each protrusion corresponds to a respective contact on the circuit board, and a touch occurring between the protrusion and the contact represents the input of a predetermined instruction. As such, different instructions can be input by pressing the cap to selectively make a certain protrusion touch the corresponding contact. However, because the protrusions are all configured on a common cap, all of the protrusions are downwardly moved together to various extents when the cap is pressed. Therefore, unexpected touches may occur and lead to wrong input of instructions.

Therefore, what is needed is to provide a key device for electronic apparatuses which can overcome the above-described shortcomings

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is an isometric view of a key device in accordance with an exemplary embodiment of the present disclosure.

FIG. 2 is an exploded, isometric view of the key device in FIG. 1.

FIG. 3 is an enlarged, vertical view of the keyboard 16 of the key device in FIG. 2.

FIG. 4 is an isometric, bottom-up view of a keyboard frame of the key device in FIG. 2.

### DETAILED DESCRIPTION

Reference will now be made to the drawings to describe the present key device in detail.

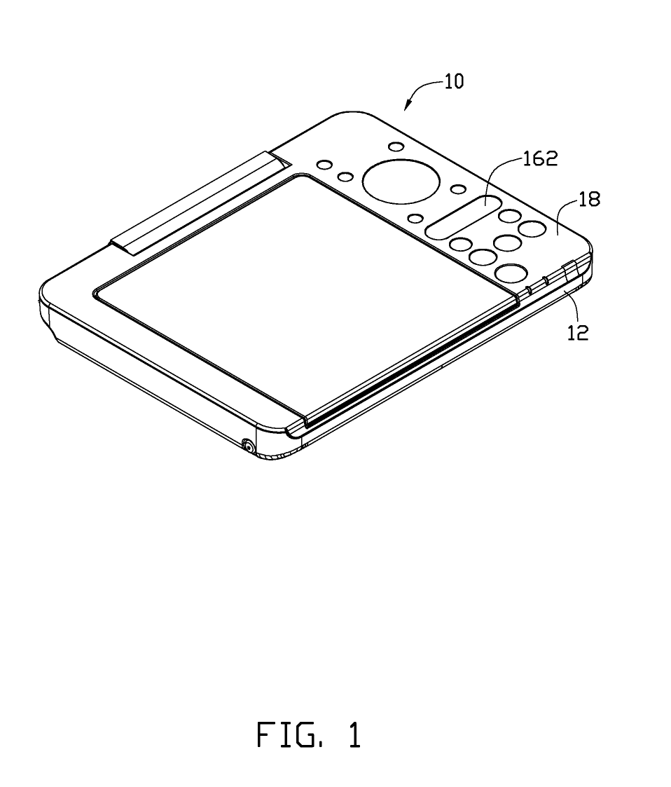

Referring to FIG. 1, a key device 10 for electronic apparatuses according to an exemplary embodiment is provided. The key device 10 can be employed in portable electrical apparatuses, such as DVD (Digital Video Disc) players.

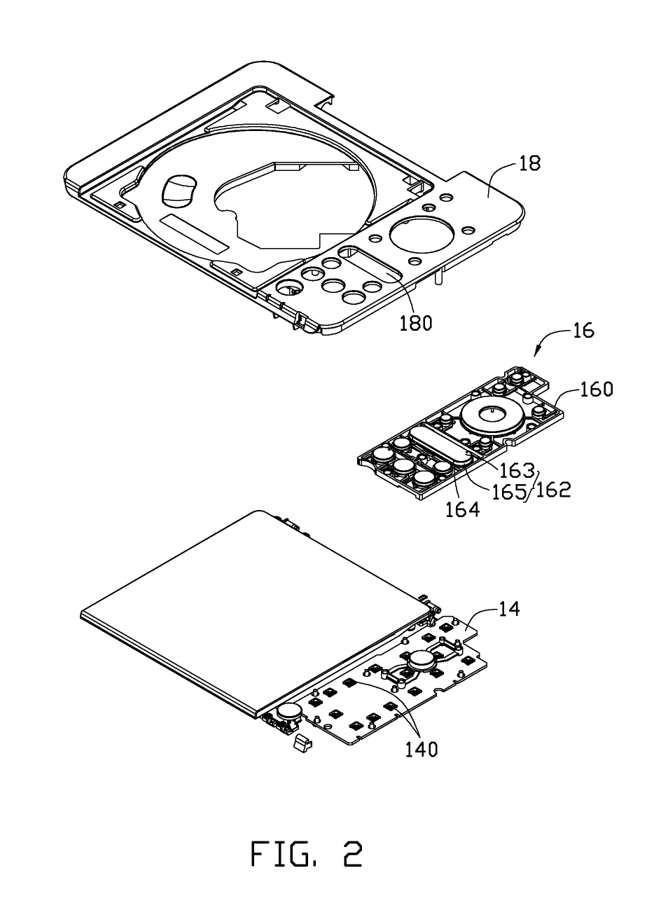

Referring also to FIG. 2, the key device 10 includes a base 12, a circuit board 14 located on the base 12, a keyboard 16 located on the circuit board 14, and an upper cover 18. In the illustrated embodiment, the base 12 is part of a base of a DVD player, and the upper cover 18 is part of an upper cover of the DVD player.

The base 12 and the upper cover 18 cooperatively form a receiving chamber which receives the circuit board 14 and the keyboard 16 therein.

The circuit board 14 has two contacts 140 configured thereon. In the present embodiment, as an example, a volume of sound output by the portable electrical apparatus can be increased or decreased by respectively pressing one of the two contacts 140.

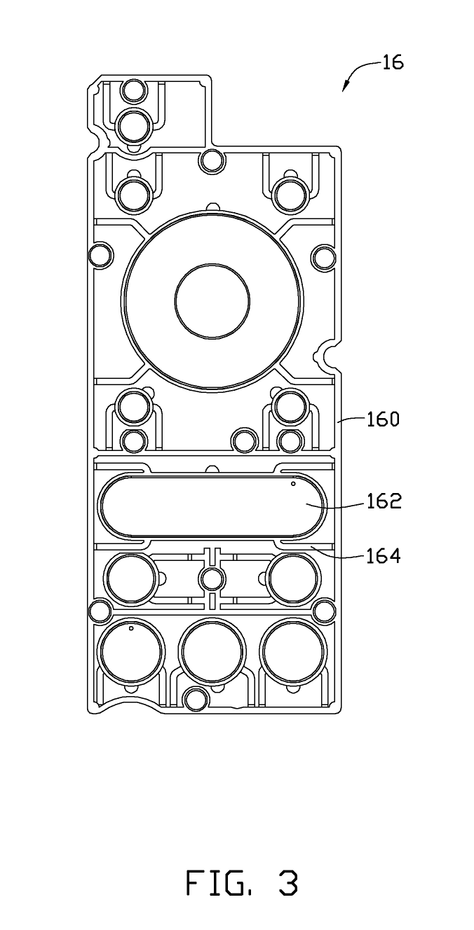

Also referring to FIG. 3, the keyboard 16 includes a frame 160, a cap 162 and a plurality of ribs 164. The frame 160 has an approximately rectangular shape. The frame 160 is located on and engaged with the circuit board 14. In the illustrated embodiment, there are four ribs 164. Two of the ribs 164 extend inwardly from a long side of the frame 160, and connect with opposite sides of one end of the cap 162, respectively. The other two ribs 164 extend inwardly from an opposite long side of the frame 160, and connect with opposite sides of an opposite end of the cap 162, respectively. Each of the four ribs 164 includes a curved end portion connected to the cap 162 and being elastically deformable. The cap 162 is thus connected to the frame 160 by the plurality of ribs 164, and thereby the cap 162 is positioned and strengthened on the frame 160.

The cap 162 includes a top plate 163 and a side wall 165. The top plate 163 is above the two contacts 140 of the circuit board 14. In this embodiment, the top plate 163 has an approximately rectangular shape, and includes two semicircular end portions at two opposite ends thereof. The side wall 165 extends from a peripheral edge of the top plate 163 towards the circuit board 14, and connects with the plurality of ribs 164. Thus the side wall 165 has a shape corresponding to the shape of the top plate 163. In a general way, the side wall 165 can be considered to have an elongated ring shape.

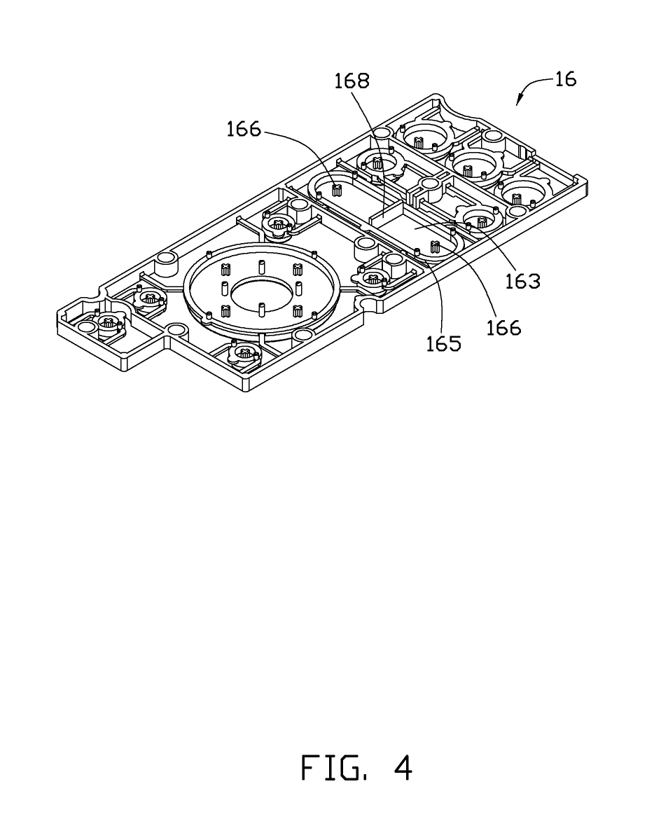

Referring also to FIG. 4, the cap 162 further includes two protrusions 166 and a partition board 168.

The two protrusions 166 are respectively located on the two semicircular end portions of the top plate 163. The two protrusions 166 extend from the top plate 163 towards the circuit board 14. Each protrusion 166 includes a distal end adjacent to and above a respective contact 140 of the circuit board 14. In the illustrated embodiment, each of the protrusions 166 is located on the top plate 163 approximately at a point on the semicircular end portion that is the center of a circle of which the semicircular end portion forms a part.

The partition board 168 extends from the top plate 163 towards the circuit board 14. The partition board 168 has a plate-like shape, spans a transverse width of the top plate 163, and is located midway between the two protrusions 166.

In this embodiment, the two protrusions 166 and the partition board 168 all extend along a direction perpendicular to a plane of the top plate 163. Furthermore, the partition board 168 configures located in a plane perpendicular to an imaginary line between the two protrusions 166.

In this embodiment, the partition board 168 is configured to have its two ends connecting with the side wall 165. In alternative embodiments, the partition board 168 can be isolated from the side wall 165.

The protrusions 166 and the partition board 168 each have a height. The height of each protrusion 166 is smaller that that of the partition board 168. When assembled with the circuit board 14, the frame 16 has the partition board 168 abutting against the circuit board 14, and the distal ends of the protrusions 166 are located above and isolated (spaced) from the contacts 140 of the circuit board 14.

The upper cover 18 includes a through hole 180 corresponding to the cap 162. The through hole 180 has a profile similar to that of the cap 162. The size of the through hole 180 is slightly greater than that of the cap 162. Accordingly, when assembled with the upper cover 18, the frame 16 has the cap 162 penetrating the through hole 180 and exposed at the outside of the upper cover 18.

When one side of the cap 162 is pressed downwardly, the cap 162 pivots on the partition board 168. The corresponding protrusion 166 moves slantingly downwardly and the other protrusion 166 moves slantingly upwardly due to the tilting of the cap 162. As such, only the one protrusion 166 touches the corresponding contact 140 at the one time. That is, the two contacts 140 cannot be touched on the corresponding contact 140 at the same time. Therefore different or conflicting instructions cannot be input to the portable electrical apparatus simultaneously.

In various embodiments, the circuit board 14 is not limited to including only two contacts 140. The circuit board 14 can also include more contacts 140 to achieve the input of more kinds of instructions.

It is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

What is claimed is:

1. A key device comprising:
a circuit board with two contacts thereon;
a keyboard with a frame and a cap, the frame being located on the circuit board, the cap being movably connected to the frame;
wherein the cap comprises a top plate, a partition board and two protrusions, the top plate is above the circuit board, the partition board extends down from the top plate and abuts against the circuit board, the two protrusions are at two opposite sides of the partition board, each protrusion extends down from the top plate, and each protrusion comprises a distal end adjacent to and above a respective one of the contacts of the circuit board.

2. The key device according to claim 1, wherein the cap further comprises a generally ring-shaped side wall extending from a peripheral edge of the top plate towards the circuit board.

3. The key device according to claim 2, wherein opposite ends of the partition board are connected with the side wall.

4. The key device according to claim 1, wherein the partition board is plate-shaped, and sits in a plane perpendicular to an imaginary line between the two protrusions.

5. The key device according to claim 1, wherein the top plate has a rectangular shape with two semicircular end portions formed at two opposite ends thereof.

6. The key device according to claim 1, wherein the protrusions and the partition board each have a height, and the height of each of the protrusions is smaller than that of the partition board.

7. The key device according to claim 1, wherein the cap is connected to the frame by a plurality of ribs.

8. The key device according to claim 1, further comprising a base and an upper cover, wherein the base and the upper cover cooperatively form a receiving chamber receiving the circuit board and the keyboard.

9. The key device according to claim 8, wherein the upper cover comprises a through hole corresponding to the cap, and the cap penetrates the through hole and is exposed to an outside of the upper cover.

10. A key device comprising:
a circuit board with two contacts thereon; and
a cap comprising two protrusions and a pivot board between the two protrusions;
the two protrusions spatially corresponding to the two contacts, a bottom of the pivot board abutting against the circuit board, the cap capable of pivoting about the bottom of the pivot board when the cap is pressed by a user, wherein one protrusion moves slantingly down to touch a corresponding one of the contacts and the other protrusion moves slantingly up away from the other contact due to tilting of the cap.

11. The key device according to claim 10, wherein the cap further comprises a top plate, the two protrusions and the pivot board all extend from a bottom surface of the top plate, and the bottom surface of the top plate faces the circuit board.

12. The key device according to claim 10, further comprising a frame engaged with the circuit board and a plurality of ribs elastically connecting the cap with the frame.
